(19) United States
(12) Patent Application Publication
(10) Pub. No.: US 2024/0119117 A1
(43) Pub. Date: Apr. 11, 2024

(54) DATA ANALYSIS METHOD SELECTION DEVICE METHOD AND PROGRAM

(71) Applicant: Nippon Telegraph and Telephone Corporation, Tokyo (JP)

(72) Inventors: Taizo YAMAMOTO, Musashino-shi, Tokyo (JP); Takaaki MORIYA, Musashino-shi, Tokyo (JP); Manabu NISHIO, Musashino-shi, Tokyo (JP); Yu MIYOSHI, Musashino-shi, Tokyo (JP)

(21) Appl. No.: 18/277,003

(22) PCT Filed: Feb. 16, 2021
(86) PCT No.: PCT/JP2021/005698

§ 371 Date: Aug. 11, 2023

(51) Int. Cl. G06F 17/18; G06F 16/2457; G06F 16/28

(52) U.S. Cl. CPC G06F 17/18; G06F 16/24573; G06F 16/285

(57) ABSTRACT

A device includes: a data set including multiple sets in which two pieces of time-series data are respectively recorded; an analysis unit that obtains evaluation values representing a relationship between the two pieces by different analysis methods for each set; a combination extraction unit that extracts combinations of the sets having different trends in change in the evaluation values associated with the analysis methods; a grouping unit that classifies the analysis methods according to the evaluation values for each combination, and records results associated with the sets; an inquiry unit that presents the time-series data of each set to a user, and inquires which sets have similar time-series data; a scoring unit that adds a score of the analysis method belonging to the group having a better evaluation value for the set determined to be more similar; and a selection unit that repeats each process and selects an analysis method.

### TECHNICAL FIELD

The present invention relates to a data analysis method selection device, method, and program.

### BACKGROUND ART

In order to analyze and evaluate a set of data, support of a data scientist (hereinafter referred to as a “DS”) may be received. A DS is tasked with supporting decision-makers in making rational determinations based on data in various decision-making phases.

Although a DS is an expert familiar to each field, there are some fields in which he or she does not have know-how. Therefore, when the DS does not have know-how, appropriate data analysis cannot be performed.

On the other hand, as a data analysis device, for example, PTL 1 discloses a device which obtains regularity in a data set such as time-series data, calculates an index value indicating the amount of change over time of each piece of data, and graphs the time-series data.

### CITATION LIST

### Patent Literature

[PTL 1] Japanese Patent No. 6592411

### SUMMARY OF INVENTION

### Technical Problem

However, the technique disclosed in PTL 1 arranges and displays a plurality of time-series data graphs in the order according to the obtained index values. Therefore, there is a case where the displayed graph is not desired by a user. That is, there is a problem that feedback of the user is not effective for the analysis result.

As described above, in the related art, there has been no mechanism for presenting the results of a plurality of analysis methods to the user on the basis of the assumption that there is no complete analysis method, and for the user to select a better analysis method.

The present invention has been made in view of this problem, and an object thereof is to provide a data analysis method selection device, method, and program capable of narrowing down an appropriate analysis method by making feedback of a user effective even when there is no know-how, and selecting appropriate data analysis.

### Solution to Problem

A data analysis method selection device according to one aspect of the present invention includes: a data set including a plurality of sets in which two pieces of time-series data are respectively recorded; an analysis unit that obtains evaluation values representing a relationship between the two pieces of time-series data by different analysis methods for each of the sets; a combination extraction unit that extracts combinations of the sets having different trends in change in the evaluation values in association with the analysis methods; an analysis method grouping unit that classifies the analysis methods into groups according to pass/fail of the evaluation values for each of the combinations extracted by the combination extraction unit, and records results of the classification in association with the sets; an inquiry unit that presents the time-series data of each set of the combinations extracted by the combination extraction unit to a user, and inquires of the user which sets have similar time-series data; a scoring unit that adds a score of the analysis method belonging to the group having a better evaluation value for the set determined to be more similar in an answer of the user; and an analysis method selection unit that repeats each process of the combination extraction unit, the analysis method grouping unit, the inquiry unit, and the scoring unit, and selects the analysis method in which the score becomes a predetermined value.

A data analysis method selection method according to one aspect of the present invention is a method performed by the above data analysis method selection device, the method including: an analysis step in which an analysis unit obtains evaluation values representing a relationship between two pieces of time-series data by different analysis methods for each of sets in which the pieces of time-series data are respectively recorded; a combination extraction step in which a combination extraction unit extracts combinations of the sets having different trends in change in the evaluation values in association with the analysis methods; an analysis method grouping step in which an analysis method grouping unit classifies the analysis methods into groups according to pass/fail of the evaluation values for each of the combinations extracted in the combination extraction step, and records results of the classification in association with the sets; an inquiry step in which an inquiry unit presents the time-series data of each set of the combinations extracted by the combination extraction unit to a user, and inquires of the user which sets have similar time-series data; a scoring step in which a scoring unit adds a score of the analysis method belonging to the group having a better evaluation value for the set determined to be more similar in an answer of the user; and an analysis method selection unit that repeats each process of the combination extraction step, the analysis method grouping step, the inquiry step, and the scoring step, and selects the analysis method in which the score becomes a predetermined value.

Furthermore, a program according to one aspect of the present invention is a program for causing a computer to function as the above data analysis method selection device.

### Advantageous Effects of Invention

According to the present invention, it is possible to provide a data analysis method selection device, method, and program capable of narrowing down an appropriate analysis method by making feedback of a user effective even when there is no know-how, and selecting an appropriate data analysis method.

### BRIEF DESCRIPTION OF DRAWINGS

FIG. 1 is a diagram showing an example of a configuration of a data analysis method selection device according to an embodiment of the present invention.

FIG. 2 is a diagram showing examples of time-series data of a certain set and evaluation values obtained by analyzing the time-series data by different analysis methods.

FIG. 3 is a diagram schematically showing an example of an evaluation value table shown in FIG. 1.

FIG. 4 is a diagram schematically showing an example of a score table shown in FIG. 1.

FIG. 5 is a diagram illustrating an action of an analysis method selection unit shown in FIG. 1.

FIG. 6 is a diagram illustrating an analysis method (1).

FIG. 7 is a diagram illustrating an analysis method (2).

FIG. 8 is a diagram illustrating an analysis method (3).

FIG. 9 is a diagram illustrating an analysis method (4).

FIG. 10 is a flowchart showing a processing procedure of the data analysis method selection device shown in FIG. 1.

FIG. 11 is a block diagram showing an example of a configuration of a general-purpose computer system.

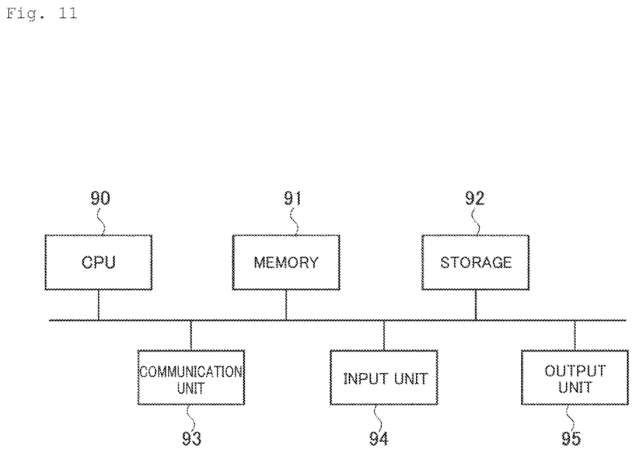

### DESCRIPTION OF EMBODIMENTS

An embodiment of the present invention will be described below with reference to the drawings. The same elements in a plurality of drawings are given the same reference numerals in order not to repeat description.

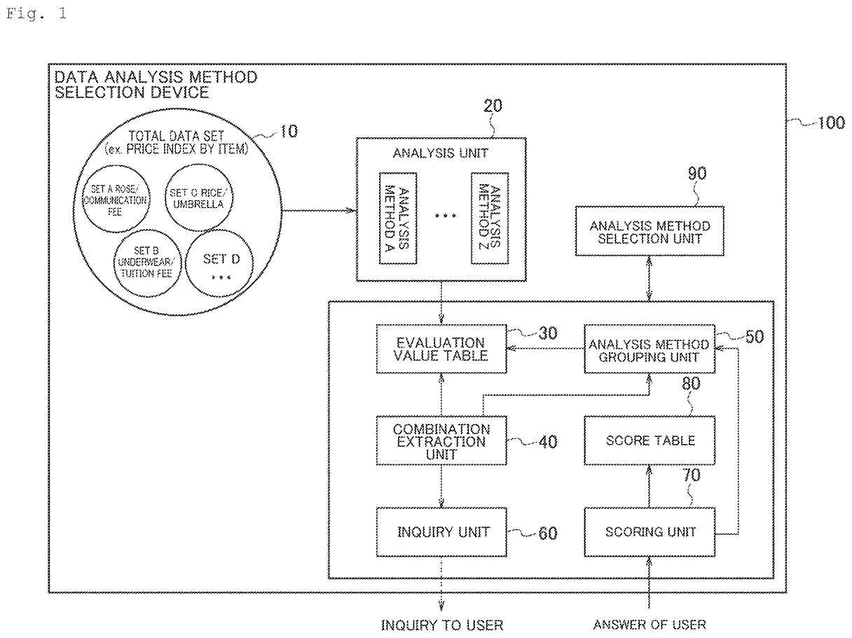

FIG. 1 is a diagram showing an example of a configuration of a data analysis method selection device according to an embodiment of the present invention. A data analysis method selection device 100 shown in FIG. 1 narrows down an appropriate analysis method by making feedback of a user effective, and selects an appropriate data analysis method.

The data analysis method selection device 100 includes a data set 10, an analysis unit 20, an evaluation value table 30, a combination extraction unit 40, an analysis method grouping unit 50, an inquiry unit 60, a scoring unit 70, a score table 80, and an analysis method selection unit 90. The data analysis method selection device 100 can be realized by, for example, a computer including a ROM, a RAM, a CPU, and the like. In this case, the processing content of each functional component to be provided in the respective devices is described by a program.

The data set 10 includes a plurality of sets A, B, C, D, . . . in which two pieces of time-series data are respectively recorded. The set A is, for example, a record of changes in price indexes of cut flowers (roses) and information communication related expenses. The set B is, for example, a record of changes in the price indexes of underwear and tuition fees.

The analysis unit 20 obtains evaluation values representing the relationship between the two pieces of time-series data by different analysis methods for each of the sets A, B, . . . . The analysis method is, for example, a plurality of analysis methods in the head of the DS.

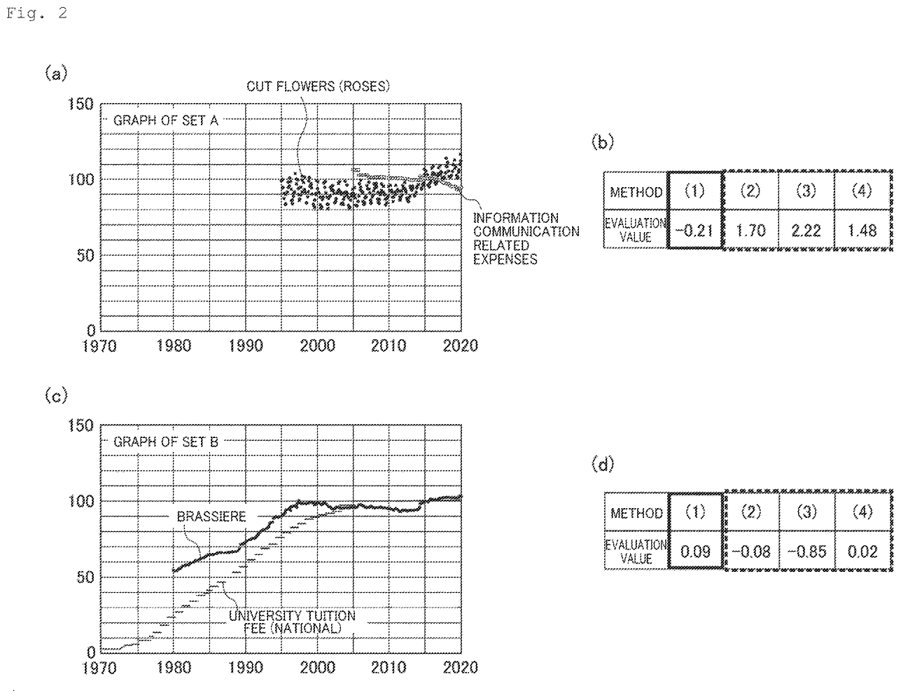

FIG. 2 is a diagram showing examples of time-series data of a data set and evaluation values obtained by analyzing the time-series data by different analysis methods. FIG. 2(a) shows time-series data of price indexes of cut flowers (roses) and information communication related expenses. FIG. 2(b) shows evaluation values analyzed by each of four analysis methods (1) to (4), for example.

The evaluation value is, for example, a numerical value which decreases when two pieces of time-series data of the set A are similar to each other. A specific calculation method of the evaluation value will be described below.

FIG. 2(c) shows time-series data of price indexes of underwear (brassiere) and university tuition fee (national). FIG. 2(d) shows evaluation values obtained by analyzing the two pieces of time-series data shown in FIG. 2(c) by each of the analysis methods (1) to (4).

The evaluation value table 30 is a table of evaluation values obtained by analyzing each of the sets A, B, . . . by different analysis methods. The evaluation value table 30 is a table in which rows are recorded for each of the sets A, B, . . . , and columns are recorded for each analysis method.

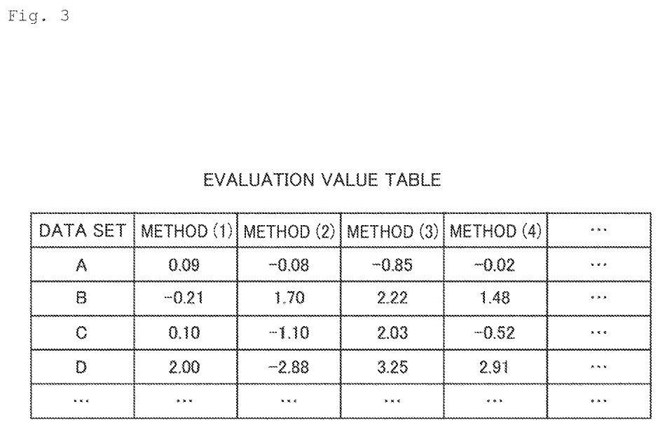

FIG. 3 is a diagram showing an example of the evaluation value table 30. Each row of the table corresponds to the sets A, B, . . . , and each column corresponds to the analysis method. The evaluation values of the sets A and B of FIG. 3 are different from those of the sets A and B of FIG. 2 for convenience of description.

The evaluation value of the analysis method (1) of the set A is 0.09, the middle omission is performed, and the evaluation value of the analysis method (4) is −0.02. The analysis method is not limited to four kinds of methods (1) to (4).

The combination extraction unit 40 extracts a combination of sets having different trends in change in the evaluation value in association with the analysis methods. The combination extraction unit 40 extracts, for example, a combination of the set A and the set B.

The trend in change of the evaluation values is different when the evaluation values of the analysis methods (1) to (4) are reversed, for example, as shown in the sets A and B in FIG. 3. In the set A, the evaluation value of the analysis method (1) is large, and the evaluation values of the analysis methods (2) and (3) are large.

On the other hand, in the set B, the evaluation value of the analysis method (1) is small, and the evaluation values of the analysis methods (2) and (3) are large. In this example, the combination extraction unit 40 extracts a combination of the set A and the set B.

In this way, the combination extraction unit 40 extracts a combination of a set in which the trend of the evaluation value is opposite and the difference of the evaluation value is large.

The analysis method grouping unit 50 classifies the classification methods into groups according to pass/fail of the evaluation values for each of the combinations extracted by the combination extraction unit 40, and records results of the classification in association with the sets. For pass/fail of the evaluation value, for example, an evaluation value of a small numerical value is “pass” when two pieces of time-series data are similar to each other, and for example, an evaluation value of a large numerical value is “fail” when two pieces of time-series data are similar to each other.

In the case of the set A shown in FIG. 3, the analysis method (1) is grouped as “fail” and the analysis methods (2) to (4) are grouped as “pass.” In the case of the set B shown in FIG. 3, the analysis method (1) is grouped as “pass” and the analysis methods (2) to (4) are grouped as “fail.”

The evaluation value table shown in FIG. 3 does not explicitly indicate the pass/fail of the analysis method. The pass/fail may be indicated by pass/fail flags corresponding to the squares of the table, for example.

The inquiry unit 60 presents the time-series data of each set of the combinations extracted by the combination extraction unit 40 to the user, and inquires of the user which sets have similar time-series data. The inquiry is made by displaying, for example, “Which of the set A and the set B is more similar?” or the like on an operation panel (not shown) or the like.

The scoring unit 70 adds a score of the analysis method belonging to the group having a better evaluation value for the set determined to be more similar in the answer of the user. The answer of the user is made by the user touching an operation panel (not shown) constituted by a touch panel, for example.

The answer of the user is either the time-series data of one set being more similar, the data set of the other set being more similar, or unknown. Thus, the sensitivity of the user (person) can be appropriately taken in.

In the example shown in FIG. 2, it is assumed that the user answers that the two pieces of time-series data of the set A are more similar than those of the set B. In this case, the scoring unit 70 adds a score 1 to the analysis method (1) of the set A.

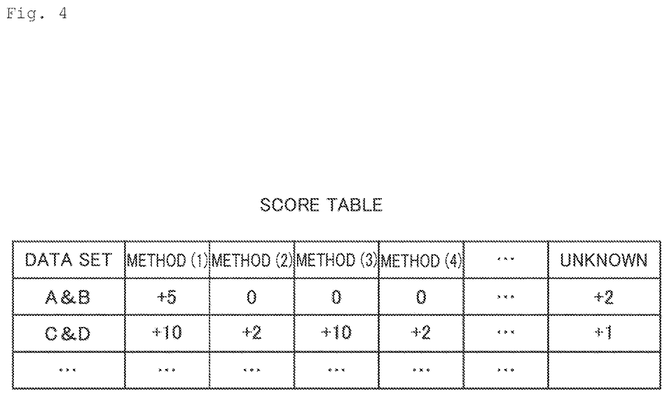

FIG. 4 is a diagram showing an example of a score table in which results obtained by adding scores by the scoring unit 70 are recorded. The example shown in FIG. 4 shows the case of inquiring the user seven times about the combination of the set A-B. Further, the example shows the case of inquiring the user 33 times about the combination of the set C-D. In the set A-B, the seven users are different persons.

As shown in FIG. 3, in the set A, the analysis method (1) is grouped as “fail” and the analysis methods (2) to (4) are grouped as “pass.” Therefore, when it is determined that the set A is more similar, the score 1 is added to the squares of the analysis methods (2) to (4).

The user does not know the analysis methods (1) to (4). The analysis methods (1) to (4) and their corresponding evaluation values are information inside the data analysis method selection device 100 and are not shown in the table. The plurality of analysis methods and the respective evaluation values are formed into a black box.

The analysis method selection unit 90 repeats each process of the combination extraction unit 40, the analysis method grouping unit 50, the inquiry unit 60, and the scoring unit 70, and selects an analysis method in which the score becomes a predetermined value.

The inquiry unit 60 presents a combination of a plurality of data sets 10 to the user by the action of the analysis method selection unit 90. The number PN of combinations of the data sets 10 to be presented to the user can be expressed by the following equation, where N is the number of sets constituting the data sets 10.

$$\\ \begin{matrix}[ Math . 1 ] & \\ PN = N \times \frac{( N - 1 )}{2} & ( 1 )\end{matrix}$$

For example, when the number of sets is three, A, B, and C, the combinations of the data sets 10 are three, A-B, B-C, and C-A. When N=100, PN=4900.

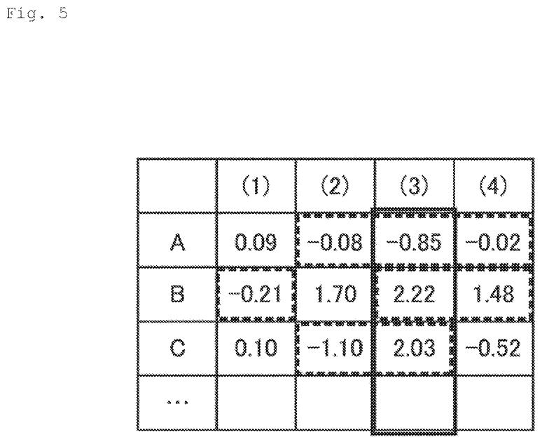

FIG. 5 is a diagram illustrating the action of the analysis method selection unit 90 when N=3. In the description, it is assumed that the trend in change in the evaluation values of the sets A, B, and C is different from each other.

The inquiry unit 60 first inquires of the user which time-series data of the combination A-B are more similar. For example, when the answer is made that the set A is more similar, the scoring unit 70 adds a score 1 to each of the analysis methods (2) and (3) because the analysis methods (2) and (3) are classified into groups having good evaluation values as shown in FIG. 5.

In this case, the methods (2) to (4) of the row of the set A-B shown in FIG. 4 have a score of +1. The notation in FIG. 4 is different.

Next, the inquiry unit 60 inquires of the user which time-series data of the combination B-C are more similar. For example, when the answer is made that the set B is more similar, the scoring unit 70 adds the score 1 to each of the analysis methods (1), (3), and (4) because the evaluation values of the groups of the analysis methods (1), (3), and (4) are better as shown in FIG. 5.

Next, the inquiry unit 60 inquires of the user which time-series data of the combination C-A are more similar. For example, when the answer is made that the set C is more similar, the scoring unit 70 adds the score 1 to each of the analysis methods (2), (3), and (4) because the evaluation values of the groups of the analysis methods (2), (3), and (4) are better as shown in FIG. 5.

As a result of the above process, among the scores of the respective analysis methods (1) to (4) in the score table, the score of the analysis method (3) is the highest with 3 points. In this case, the analysis method selection unit 90 selects the analysis method (3).

Actually, the number PN of combinations of the data sets 10 to be presented to the user is larger, and the predetermined value for selecting the analysis method is also a larger value.

As described above, the data analysis method selection device 100 according to the present embodiment includes: a data set 10 including a plurality of sets A, B, . . . in which two pieces of time-series data are respectively recorded; an analysis unit 20 that obtains evaluation values representing a relationship between the two pieces of time-series data by different analysis methods for each of the sets A, B, . . . ; a combination extraction unit 40 that extracts combinations of the sets A, B, . . . having different trends in change in the evaluation values in association with the analysis methods; an analysis method grouping unit 50 that classifies the analysis methods into groups according to pass/fail of the evaluation values for each of combinations (A-B and the like) extracted by the combination extraction unit 40, and records results of the classification in association with the sets; an inquiry unit 60 that presents the time-series data of each set of the combinations (A-B and the like) extracted by the combination extraction unit 40 to a user, and inquires of the user which sets A and B have similar time-series data; a scoring unit 70 that adds a score of the analysis method belonging to the group having a better evaluation value for the set determined to be more similar in an answer of the user; and an analysis method selection unit 90 that repeats each process of the combination extraction unit 40, the analysis method grouping unit 50, the inquiry unit 60, and the scoring unit 70, and selects the analysis method in which the score becomes a predetermined value. Thus, it is possible to provide a data analysis method selection device capable of narrowing down an appropriate analysis method by making feedback of a user effective even when there is no know-how, and selecting an appropriate data analysis method.

In the present embodiment, attention is paid to the relationship between two pieces of time-series data, the relationship is digitized, the two pieces of time-series data are imaged and presented to the user, and the answer of the user is fed back. As a result, an analysis method close to the feeling of a person (user) can be selected from a plurality of analysis methods. Therefore, the optimum analysis method can be selected even when the user does not have any expert knowledge.

That is, the present embodiment provides a mechanism for presenting the results of a plurality of analysis methods to the user on the basis of the assumption that there is no complete analysis method, and for the user to select a better analysis method. Note that a user (a subject to be described later) who is presented with the analysis method is basically different from a user who uses the data analysis method selection device 100 according to the present embodiment. The number of people who use the data analysis method selection device 100 will increase. The user who is presented with the analysis method may be one or a plurality of users.

When there is one user who is presented with the analysis method, the score added by the scoring unit 70 is 1. Even if the user who uses the data analysis method selection device 100 is changed, one optimum analysis method for analyzing time-series data of a certain set is selected.

A specific example of the analysis method will be described hereinbelow.

(Analysis Method (1))

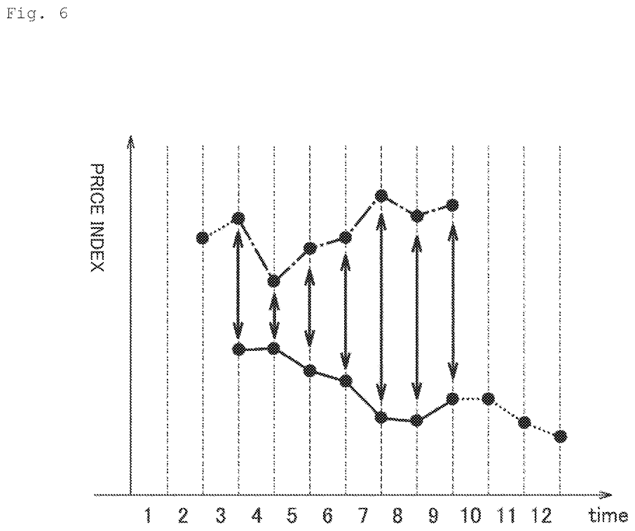

FIG. 6 is a diagram illustrating the analysis method (1). FIG. 6 shows time-series data of two price indexes. In FIG. 6, the horizontal axis represents time, the vertical axis represents price index.

The analysis method (1) divides a cumulative value of differences between the corresponding data of two pieces of time-series data by the number of pieces of accumulated data for two price indexes to be compared indicated by an alternate long-and-short dashed line and a solid line. The difference may be coded or handled as an absolute value. As indicated by a broken line in FIG. 6, when only one side has data, the addition is not performed.

The analysis method (1) is suitable for a case in which the number of two pieces of price index data to be compared is large and variation per time such as seasonal variation is small.

(Analysis Method (2))

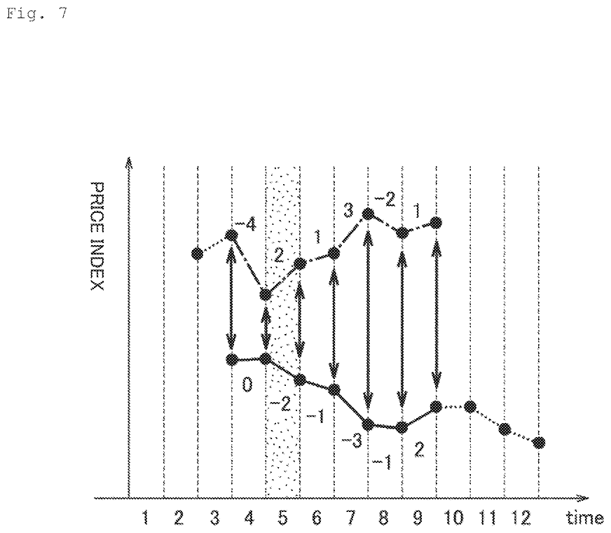

FIG. 7 is a diagram illustrating the analysis method (2). The relationship between the horizontal axis and the vertical axis in FIG. 7 is the same as in FIG. 6.

The analysis method (2) obtains respective amounts of change of two pieces of time-series data, and divides a cumulative value of differences between the amounts of change by the number of pieces of accumulated data. The difference at time 5 shown in FIG. 7 is 2−(−2)=4. Similarly to the analysis method (1), when only one side has data, the addition is not performed.

The analysis method (2) is suitable for a case in which the number of two pieces of price index data to be compared is large, the absolute value of the difference is large, and the shape of variation is similar.

(Analysis Method (3))

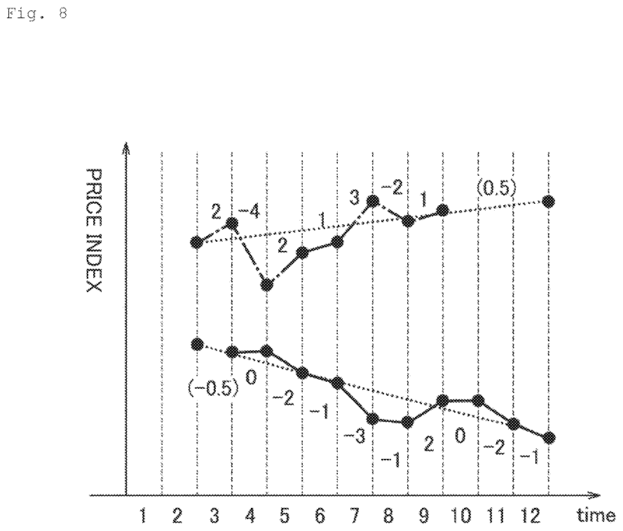

FIG. 8 is a diagram illustrating the analysis method (3). The relationship between the horizontal axis and the vertical axis in FIG. 7 is the same as in FIG. 6.

The calculation method of the analysis method (3) is basically the same as the analysis method (2). However, when there is only one of the two pieces of time-series data, the amount of change of the other time-series data is interpolated by the average value of the amount of change of the time-series data. In addition, interpolation is not performed for a section in which there is no data in both.

Compared to the analysis method (2), the analysis method (3) is suitable for a case in which one of the two pieces of time-series data to be compared has a large number of sections without data.

(Analysis Method (4))

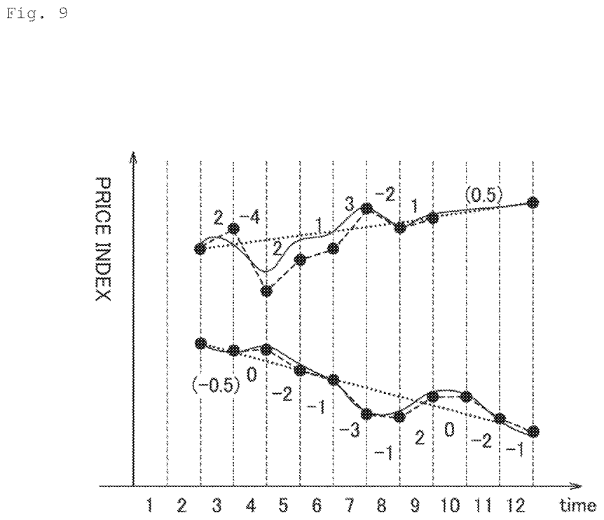

FIG. 9 is a diagram illustrating the analysis method (4). The relationship between the horizontal axis and the vertical axis in FIG. 7 is the same as in FIG. 6.

The calculation method of the analysis method (3) is basically the same as the analysis method (2). However, the average value is an average value of a plurality of amounts of change immediately before the time-series data disappears. The number of pieces of data to be averaged and weighting at the time of averaging may be changed.

This analysis method (4) is suitable for comparison of time-series data with large seasonal variation which is unsuitable for the analysis method (1).

(Data Analysis Method Selection Method)

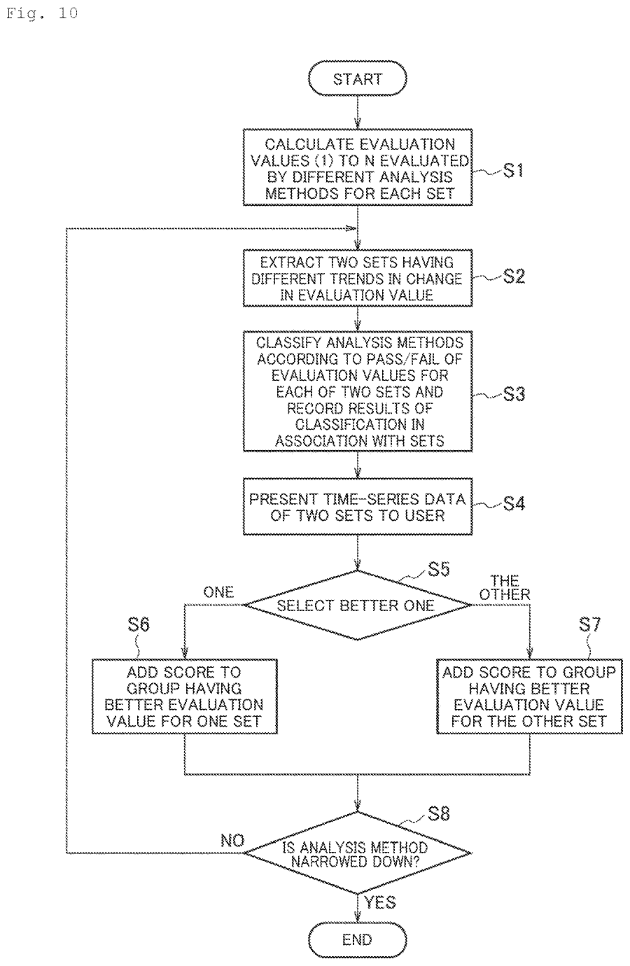

FIG. 10 is a flowchart showing a processing procedure of a data analysis method selection method performed by the data analysis method selection device 100 according to the present embodiment.

The data analysis method selection device 100 includes a data set 10 including a plurality of sets A, B, . . . in which two pieces of time-series data are respectively recorded. The data set 10 is prepared in advance. Sets . . . are added as appropriate.

The analysis unit 20 of the data analysis method selection device 100 calculates evaluation values representing the relationship between the two pieces of time-series data by different analysis methods (for example, (1) to (4) above) for each of the sets A, B, . . . (step S1).

The combination extraction unit 40 extracts combinations of sets having different trends in change in the evaluation value in association with the analysis methods (step S2). The combinations of the sets are, for example, A-B, B-C, C-A, and the like.

The analysis method grouping unit 50 classifies the analysis methods into groups according to pass/fail of the evaluation values for each of the combinations of the sets extracted by the combination extraction unit 40, and records results of the classification in association with the sets (step S3).

The inquiry unit 60 presents the time-series data of each set of the combinations extracted by the combination extraction unit 40 to the user, and inquires of the user which sets have similar time-series data (step S4).

The user answers which sets have similar time-series data (step S5). The answer is made by, for example, the user touching an operation panel (not shown) or the like.

The scoring unit 70 adds a score of the analysis method belonging to the group having a better evaluation value for the set determined to be more similar in the answer of the user. For example, when it is determined that the time-series data of the set A is more similar, a score is added to, for example, the method (1) of A-B of the sets of the score table (FIG. 4) (step S6). In addition, when it is determined that the time-series data of the set B is more similar, scores are added to, for example, the methods (2), (3), and (4) of A-B of the sets of the score table (FIG. 4) (step S7).

The analysis method selection unit 90 repeats each process of a combination extraction step (step S2), an analysis method grouping step (step S3), an inquiry step (step S4), and a scoring step (step S5), and selects an analysis method in which the score becomes a predetermined value (YES in step S8). When the set is added, the process is repeated from the process (step S2) of the analysis unit 20.

The data analysis method selection device 100 can be realized by a general-purpose computer system shown in FIG. 8. For example, in a general-purpose computer system including a CPU 90, a memory 91, a storage 92, a communication unit 93, an input unit 94, and an output unit 95, each function of the data analysis method selection device 100 is realized by the CPU 90 executing a predetermined program loaded on the memory 91. A predetermined program can be recorded on a computer-readable recording medium such as an HDD, an SSD, a USB memory, a CD-ROM, a DVD-ROM, or an MO and can also be distributed via a network.

(Evaluation Experiment)

An evaluation experiment was conducted for the purpose of confirming the effect obtained by the data analysis method selection device 100 according to the present embodiment.

In the evaluation experiment, 380 items of time-series data were used from the consumer price index (price index by item) provided by the Statistics Bureau, Ministry of Internal Affairs and Communications. An experiment was carried out to select the most suitable analysis method from among analysis methods different in the calculation method of the evaluation value by using about 72,000 sets obtained by combining 380 items.

The four analysis methods (1) to (4) described above were used as the analysis methods. The selection of the set was performed 20 times per one analysis method. As a result of the prior evaluation, it was found that the analysis method (1) was most suitable for the feeling of a subject (user (person)).

Then, similar evaluations were performed on 10 randomly extracted sets for four subjects. The results are shown in Table 1.

TABLE 1

| | | Coincidence | Coincidence | Coincidence | Coincidence |
|---|---|---|---|---|---|
| | Number of | rate with | rate with | rate with | rate with |
| Subject | evaluations | method (1) | method (2) | method (3) | method (4) |
| 1 | 10 | 100% | 75% | 75% | 88% |
| 2 | 10 | 80% | 60% | 50% | 60% |
| 3 | 10 | 78% | 67% | 56% | 67% |
| 4 | 10 | 100% | 67% | 67% | 78% |
| Total | 40 | 89% | 67% | 61% | 72% |

As shown in Table 1, it was found that the analysis method (1), which was determined to be most suitable for the subject in the prior evaluation, had the highest coincidence rate of 89% on average, and the analysis method can be selected with a relatively small number of trials by using the data analysis method selection device 100.

According to the present embodiment, by paying attention to the relationship between the time-series data which are the set of two pieces of data, not only digitizing the relationship but also visualizing and presenting to the user, and obtaining an answer from the user, an analysis method close to the feeling of a person can be selected from among a plurality of analysis methods.

That is, unlike a DS, even a user having no know-how can select an appropriate data analysis method.

In the above example, the analysis methods have been described by four kinds of methods (1) to (4), but the present invention is not limited to this example. The number of analysis methods may be n (n is a natural number). Also, the analysis method is not limited to the above example. Further, although the sets A and B are shown by taking time-series data of the price index as an example, other time-series data may be used.

In this manner, the present invention includes various embodiments etc., not described herein, as a matter of course. Thus, the technical scope of the present invention is only defined by invention specifying matters in the claims that are appropriate from the above description.

### REFERENCE SIGNS LIST

10: Data set
20: Analysis unit
30: Evaluation value table
40: Combination extraction unit
50: Analysis method grouping unit
60: Inquiry unit
70: Scoring unit
80: Score table
90: Analysis method selection unit
100: Data analysis method selection device
A, B, C, D: Set

1. A data analysis method selection device comprising:
a memory configured to store a data set including a plurality of sets in which two pieces of time-series data are respectively recorded; and
at least one processor coupled to the memory and configured to perform operations comprising:
obtaining evaluation values representing a relationship between the two pieces of time-series data by different analysis methods for each of the sets;
extracting combinations of the sets having different trends in change in the evaluation values in association with the analysis methods;
classifying the analysis methods into groups according to pass/fail of the evaluation values for each of the combinations extracted by the combination extraction unit, and recording results of the classification in association with the sets;
presenting the time-series data of each set of the combinations extracted to a user, and inquiring of the user which sets have similar time-series data;
adding a score of an analysis method belonging to the group having a better evaluation value for the set determined to be more similar in an answer of the user; and
repeating each of the extracting, the classifying, the recording, the presenting, the inquiring, and the adding, and selecting the analysis method in which the score becomes a predetermined value.

2. The data analysis method selection device according to claim 1, wherein the answer of the user is
either the time-series data of one set being more similar, the time-series data of the other set being similar, or unknown.

3. The data analysis method selection device according to claim 1, wherein one of the analysis methods includes
dividing a cumulative value obtained by accumulating differences between corresponding data of the two pieces of time-series data by the number of pieces of accumulated data.

4. The data analysis method selection device according to claim 1, wherein one of the analysis methods includes
obtaining an amount of change of each of the two pieces of time-series data, and dividing a cumulative value obtained by accumulating differences of the amount of change by the number of pieces of accumulated data.

5. The data analysis method selection device according to claim 4, wherein one of the analysis methods includes
interpolating, when there is only one of the two pieces of time-series data, the amount of change of the other time-series data by an average value of the amount of change of the time-series data.

6. The data analysis method selection device according to claim 5, wherein the average value is
an average value of a plurality of the amounts of change immediately before the time-series data disappears.

7. A data analysis method selection method comprising:
obtaining evaluation values representing a relationship between two pieces of time-series data by different analysis methods for each of sets in which the pieces of time-series data are respectively recorded;
extracting combinations of the sets having different trends in change in the evaluation values in association with the analysis methods;
classifying the analysis methods into groups according to pass/fail of the evaluation values for each of the combinations extracted in the combination extraction step, and recording results of the classification in association with the sets;
presenting the time-series data of each set of the combinations extracted by the combination extraction unit to a user, and inquiring of the user which sets have similar time-series data;
adding a score of an analysis method belonging to the group having a better evaluation value for the set determined to be more similar in an answer of the user; and
repeating each of the extracting, the classifying, the recording, the presenting, the inquiring, and the adding, and selecting the analysis method in which the score becomes a predetermined value.

8. (canceled)

9. A non-transitory computer-readable medium storing program instructions that, when executed, cause one or more processors to perform operations comprising:
obtaining evaluation values representing a relationship between two pieces of time-series data by different analysis methods for each of sets in which the pieces of time-series data are respectively recorded;
extracting combinations of the sets having different trends in change in the evaluation values in association with the analysis methods;
classifying the analysis methods into groups according to pass/fail of the evaluation values for each of the combinations extracted in the combination extraction step, and recording results of the classification in association with the sets;
presenting the time-series data of each set of the combinations extracted by the combination extraction unit to a user, and inquiring of the user which sets have similar time-series data;
adding a score of an analysis method belonging to the group having a better evaluation value for the set determined to be more similar in an answer of the user; and
repeating each of the extracting, the classifying, the recording, the presenting, the inquiring, and the adding, and selecting the analysis method in which the score becomes a predetermined value.
